(19) United States
(12) Patent Application Publication
(10) Pub. No.: US 2006/0233936 A1
(43) Pub. Date: Oct. 19, 2006

(54) Vegetable and fruit nutrients-enriched rice

(75) Inventor: Tse Wen Chang, Taipei (TW)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Juizup, Co. Ltd., Taipei (TW)

(21) Appl. No.: 11/387,852

(22) Filed: Mar. 24, 2006

(30) Foreign Application Priority Data
Mar. 25, 2005 (TW) 094109521
Apr. 1, 2005 (CN) 2005100598887

(51) Int. Cl. A23L 1/212

(52) U.S. Cl. 426/615

(57) ABSTRACT

This invention chooses vegetables and fruits that are rich in vitamins, minerals, and anti-oxidants, and uses them to prepare juice. The separately prepared juices, combined altogether or in sets, are used to cook rice without additional water, so that the rice grains absorb and adsorb the nutrients. This nutrients-enhanced rice, prepared by cooking in juice from vegetables and fruits and referred to as “Juiced-up Rice,” can be used alone or as an ingredient in preparing other rice-containing food.

### BACKGROUND OF THE INVENTION

Rice is a staple food for people living in many regions of the world. Those people, who regularly use other grains as staple food, are increasingly using rice in their diet. Polished rice is a main source of carbohydrate and calorie, but it contains limited amounts of nutrients required for a healthy body. For those people using polished rice as a staple food, an ideal way of dieting is to eat an abundant variety of vegetables and fruits. However, under various conditions and for numerous reasons, many people do not eat a sufficient variety of vegetables and fruits. Large populations of people in many regions of the world are deficient of iron and Vitamin A and are anemic or lose vision and other body functions. Many people are in poor health because of deficiency of vitamins in the B group, Vitamin E, zinc, selenium, etc. Still many more people living in both impoverished and economically developed regions are in a state of weakness or tiredness because of insufficient intake of a broad array of nutrients.

Developing and providing nutrients-enriched rice and other grains has been an important industrial field for many years. As brown rice is milled into polished (white) rice, which is preferred by most people eating rice, many nutrients, such as niacin, thiamin, riboflavin, folic acid (belonging to the Vitamin B group), are lost along with the removal of bran. Many countries have developed the technology and products of “parboiled rice”. In “parboiling” technology, the shell-containing rice grains are treated with pressurized steam and then soaked in hot water, so as to cause the nutrients contained in the bran to be dissolved into and retained in the endosperm part of the rice grains. As such processed rice grains are dried and milled into polished grains (appearing light yellowish), the polished grains contain parts of the nutrients contained originally in the bran.

Hoffman-La Roche Company developed the technology to spray vitamins to polished rice and provided vitamin-enriched rice products as early as 60 years ago. In the past 20 to 30 years, many researchers in the U.S.A., Japan, China, and other countries have engaged in the research and development of nutrients-enriched rice and grains, as witnessed by the appearance of tens of patents and inventions in this particular area. These inventions employ new chemical processes and new technologies to fortify rice or other grains with various nutrients that are purified from natural sources or synthesized chemically.

The technologies that have been developed or are being developed for producing nutrients-enriched rice can be classified into several categories. Along the line of composition and ingredients, in addition to the few common vitamins and minerals used earlier for enhancing rice, calcium, zinc, and selenium are also included. New methods and chemical formulations are developed for facilitating absorption and for improving thermal stability of nutrients, such as iron, calcium, and folic acid (USP20040228950, CN1123619, CN1227066). Other inventions on enhancing fortification processes include various coating and soaking methods. New coating methods include using starch, gelatin, cyclodextrin, oil, fat, and wax to enhance coating of nutrients onto the surface of rice grains (JP56131349, JP56131349, CN1114539, JP58013356, U.S. Pat. No. 4,765,996, JP2003245049). An invention pertains to a machine for spraying and coating (JP2004275082). Another invention pertains to soaking dry rice grains in ethanol containing nutrients and then evaporating off the ethanol (JP56124357). Another invention pertains to soaking rice seeds with zinc containing solution before seeding process and to spraying zinc compounds to rice fields, so as to increase the zinc content in the rice grains produced (CN1404714).

The advent of biotechnology has enabled scientists to transfer individual genes or sets of genes responsible for synthesizing certain vitamins into the chromosomes of rice plants. Such transgenic rice plants can produce the desired vitamins or pro-vitamins in the rice grains. A transgenic rice plant capable of producing Vitamin A in rice grains has been developed. In such transgenic rice plant engineered for producing Vitamin A, the genes of three enzymes involved in synthesizing β-carotene were transferred into the rice plant, enabling the plant to synthesize β-carotene (the precursor of Vitamin A) in the endosperm (Ye et al. 2000). The transgenic rice, which polished rice grains appear yellowish and hence are referred to as “Golden Rice”, provides a solution to thousands of patients in many regions of the world, who lack Vitamin A and are susceptible to develop blindness and other diseases. Gene transfer technology can also be applied to rice plants, so that they produce rice grains that are enriched for other vitamins or minerals. An example is a rice plant that expresses ferritin (an iron binding and storage protein) in rice grains (Lucca et al. 2002), which can be used by people deficient of iron. Despite of these promising technological advances, transgenic technology for providing nutrients-enriched rice is difficult to promote partly because of long-term safety issues and partly because more than several hundred strains of rice are used in different regions of the world.

People residing in some regions of the world are frequently severely deficient in certain vitamins and minerals for various reasons and develop diseases. Therefore, providing rice enriched with one or several pertinent nutrients can solve those problems caused by the deficiencies in nutrients. Also, the life span of people living in different parts of the world is getting longer. As a result, the aging populations are increasing and diseases, such as cardiovascular diseases, cancer, and organ degenerative diseases (vision loss, memory loss, etc.) that occur more frequently among aging populations, are becoming more prevalent. The natural substances that can prevent from those diseases are a group of important nutrients that should be provided in the diet of people living in modern times. In the field of nutrients-enriched rice, there has been very little research that develops methods to enrich rice with nutrients, such as lutein, lycopene, isothiocyanates, flavonoids, and allicin (contained in certain vegetables and fruits), which have been reported to prevent cardiovascular diseases, cancer, organ degenerative diseases, etc.

### BRIEF SUMMARY OF THE INVENTION

This invention falls in the field of “nutrients-enriched rice” or “nutrients-fortified rice”. Rice is a staple food for large populations of people in the world, providing as the main source of carbohydrates and calorie (energy). Because polished rice contain limited amounts of nutrients, those people using rice as a staple food must obtain their required nutrients from foods other than rice or food supplements. Overall speaking, vegetables can provide essentially all of the nutrients, including vitamins, minerals, anti-oxidants, and fibers. Fruits as a whole can also provide a broad spectrum of nutrients. This invention pertains to the concept and process of preparing rice preparations that are enhanced with nutrients derived from vegetables and fruits.

### BRIEF DESCRIPTION OF THE DRAWINGS

The patent or application file contains drawings executed in color. Copies of this patent or patent application publication with color drawings will be provided by the Office upon request and payment of the necessary fee.

FIG. 1 shows respectively rice cooked with juices prepared from red and orange vegetables and from green vegetables.

FIG. 2 shows the minute plant tissue bits adsorbed to the surface of rice grains that were cooked in juices prepared from green vegetables and from red and orange vegetables.

FIG. 3 shows mixed rice grains with grains cooked in juice prepared from green vegetables and grains cooked in juice prepared from red and orange vegetables.

### DETAILED DESCRIPTION OF THE INVENTION

Vegetables and Fruits Contain a Broad Spectrum of Nutrients

In order to maintain proper body health and functions, one must take in adequate amounts of required nutrients. Overall speaking, vegetables can provide essentially all of the nutrients required by the body, and fruits as a whole can also provide a broad spectrum of nutrients. The nutrients that are required by the human body and that can be provided by vegetables and fruits include common nutrients, such as various vitamins, minerals, essential amino acids and fatty acids, anti-oxidants, and fibers. Many of these nutrients are substances involved in the growth and metabolism of cells in the vegetable and fruit plants. Those plants synthesize some small and large molecules that human cells cannot make. The plants also absorb minerals from the environment (soil, water, and air), which are beneficial or essential for our bodies' health.

The nutrients that the human body needs and that vegetables and fruits can provide are very broad and complex. The vitamins include Vitamin A, niacin (Vitamin B1), riboflavin (Vitamin B2), thiamin (Vitamin B3), pyridoxine (Vitamin B6), folic acid, Vitamin B12, Vitamin C, Vitamin E, etc. The minerals include calcium, phosphorus, iron, sodium, potassium, magnesium, tin, zinc, copper, selenium, etc. People are living longer than ever and there exist in our living environment abundant oxidizing substances that cause mutations in our genes and are carcinogenic. Hence, we must take in sufficient anti-oxidants to counter such harmful agents. Some vitamins, such as Vitamin C and Vitamin E, etc. and some minerals, such as zinc, copper, and selenium, can not only play auxiliary (cofactor) roles in the complex biochemical pathways in our body's metabolism, but also act as agents that counter and neutralize the harmful oxidizing agents that get into our bodies. The anti-oxidants contained in vegetables and fruits amount to at least several hundreds. The better known ones include lutein, sulfur-containing compounds sothiocyanates, lycopene, flavonoids (e.g. resveratrol, proanthocyanidin), selenium methyl selenocysteine (a selenium compound, and allicin, etc., which are not categorized as vitamins and minerals. Increasing research provides ample evidence suggesting that anti-oxidants are effective in preventing cancer, lowering cholesterol, and protecting against aging of organs and tissues. Vegetables and fruits also contain rich amounts of fibers, including soluble and insoluble fibers. The soluble fibers contain complex polysaccharide, pectin, which is used to cause fruit extracts to form gelatin. Pectin has colon cleansing effects and can also be used to treat diarrhea. Fibers are also beneficial in protection against cardiovascular diseases and colon cancer.

Vegetables and fruits of different species and categories present nutrients of different compositions and proportions. For example, spinach is rich in vitamin A, folate, iron, calcium, riboflavin, Vitamin B6, and lutein, etc.; broccoli is rich in Vitamin C, folate, isothiocyanate, selenium methyl selenocysteine, etc.; tomato is rich in Vitamin C, phosphorus, lycopene, etc.; carrot is rich in Vitamin A, potassium, etc.; garlic is rich in allicin, selenium methyl selenocysteine, etc.; red grapes are rich in flavonoids (reservatrol in skin and proanthocyanidin in seeds); mushrooms are rich in niacin, zinc, copper, etc. Scientists continue to discover in vegetables and fruits, in addition to the commonly known nutrients, previously unknown ingredients, which have health-related benefits. In all, one should derive nutrients from broad spectrum of vegetables and fruits.

In recent years, many nutritionists have done research on the beneficial effects of juices derived from vegetables and fruits and advocate the use of vegetable and fruit juices as a source of required nutrients. The juice of vegetables and fruits, which is prepared by common juicing or blending apparatus, contains water, soluble substances, and fine particles. The fine particles are minute, broken pieces of tissues of vegetables and fruits that result from the juicing or blending processes. According to chemical analyses, vegetable and fruits juice contain many kinds of small molecules and ions of organic and inorganic nature, including vitamins, minerals, amino acids, numerous metabolites, nucleotides, fatty acids, monosaccharides, oligosaccharides, etc.; macromolecules, such as proteins, nucleic acids, etc., and soluble and insoluble fiber substances (complex polysaccharides).

Benefit of the Present Invention

Many people do not take in sufficient nutrients and hence have poor health and decreased immune defense function for one or more of the following reasons: lacking nutrition-related knowledge, habitually eating little or no vegetables, not buying some vegetables because of economic reasons, not being able to obtain sufficient vegetables because of transportation problems, not being able to prepare and cook vegetables because of immobility or handicap, etc. Obviously, those people have the need of nutrient enhancement.

Strictly speaking, the need to develop nutrients-enhanced rice is not because the rice people regularly use is an inadequate or inferior dietary product and hence needs improvement. Precisely speaking, the purpose for developing nutrients-enriched rice is in part to employ rice as a vehicle to deliver nutrients to those people who use rice as a staple food. After all, most people must eat staple food as the source of calorie (energy), If those people using rice as staple food can derive required nutrients while eating rice, they can then avoid the many problems caused by the deficiency of required nutrients. Based on the above reasoning, nutrients-enriched rice can not only provide nutrients to people and patients who are incapable of obtaining the nutrients but also offer common consumers convenient means to derive their required nutrients.

This invention utilizes the juices prepared from multiple, fresh vegetables and fruits to fortify the content of nutrients in rice. The rationale of the present invention can be summarized in the following four points: (1) vegetables and fruits contain a broad spectrum of nutrients required by the human body, but it is difficult to assemble those nutrients in purified forms and add into rice using the coating and soaking methods developed earlier, (2) rice grains can absorb and adsorb nutrients during cooking, if such nutrients are in the cooking liquid (here, “absorption” refers to the process in which the nutrients are taken into the inside of the rice grains, and “adsorption” refers to the process in which the nutrients adhere to the surface of the rice grains), (3) rice can serve as a vehicle for delivering nutrients to the bodies of the users, providing a convenient way to take in required nutrients for those people who use rice as staple food, and (4) the invention emphasizes the fortification of rice with those nutrients that prevent cardiovascular diseases, cancer, and organ degenerative diseases.

The existing technology of “parboiling” employs pressurized steam and soaking treatments to process onto intact rice grains, so as to cause the nutrients, particularly those in the vitamin B group, to become loose from the bran and merge into the endosperm part of the rice grains. The purpose of spraying and coating technologies, as described by the many patents and patent applications cited in this document, is to evenly stabilize purified nutrients onto the surface of dry rice grains. The purpose of soaking technology is to allow purified nutrients to penetrate into the inside of rice grains. These technologies in the prior art have not exploited: (1) rice grains can absorb and adsorb nutrients from the cooking mixture (as evidenced by the examples below) and (2) the broad spectrum of natural nutrients in vegetables and fruits, especially anti-oxidants.

The Methods of the Present Invention

The main process of the present invention chooses a set of vegetables and fruits and prepared from them individual juices by juicing procedures. Next, the juices are combined altogether or in multiple sets in desired proportions. Properly selected rice grains are then cooked in those juices without additional water in the cooking mixture. In the process of cooking, the rice grains take in the liquid and swell. The nutrients in the juice are either absorbed into the rice grains or adsorbed onto the surface of the rice grains. The rice prepared in such a process, referred to as “Juiced-up Rice,” contain the nutrients derived from the vegetables and fruits used in the process.

The preferred juicing method of the present invention is to cut the vegetables and fruits to pieces of 1-2 cm in length or diameter and then to subject them to juicing procedure. Some vegetables and fruits or their parts, e.g., the flower part of broccoli, grapes (which skin and seeds contain rich flavonoids), skinned garlic, ginger, peppermint, coriander, etc., may be ground by a blender apparatus to prepare paste (of fine particles, much smaller than rice grains) or thin paste, and used to combine with other juices in desired proportions. The paste prepared from the flower of broccoli may be combined with the juice prepared from the stems of broccoli. Green algae, such as chlorella, etc. (single-celled plants), needs not to be ground before being combined with other juices. In the process of the present invention, when the rice is cooked with juice prepared as described above, the juice is being withdrawn by the swelling rice grains, the soluble substances in the juice are being absorbed, and the particulate substances are adsorbed by the rice grains.

The juice prepared as described above does not contain large amounts of insoluble fibers. Therefore, in certain preferred embodiments of the present invention, a portion of the pulp (the pieces of vegetables and fruits after extraction process) is added back to the juice for use to cook rice. In another preferred embodiment, the pieces prepared from a subset of vegetables and fruits (without the extraction or juicing procedure) from the set of vegetables and fruits selected to prepared the Juiced-up Rice are combined with the juices of a subset of vegetables and fruits in the set (the subsets may be overlapping), and then used to cook rice. For example, in a combination of 3 vegetables, the juices prepared from the 3 vegetables are combined with the pieces prepared from 2 vegetables. In another example, in a set of selected 8 vegetables and fruits, 4 vegetables and fruits are used to prepare juices, 2 vegetables and fruits are used to prepare pieces, and 2 vegetables and fruits are used to prepare juices and pieces, and the 6 juices of vegetables and fruits and the pieces from 4 vegetables and fruits are combined for use to cook rice. In the process of cooking rice in a mixture of juices and pieces from vegetables and fruits, the liquid contained in the pieces of vegetables and fruits are also withdrawn by the swelling rice grains.

The Selection and Assembling of Vegetables and Fruits and Rice

The assembled vegetables and fruits of the present invention contain three or more vegetables and/or fruits, of which at least three vegetables and/or fruits are known to contain abundant amounts of anti-oxidants, and of which one or more vegetable is a green vegetable and one or more vegetable is a red or orange vegetable. The preferred assembled vegetables and fruits of the present invention contain five or more vegetables and/or fruits, of which at least five vegetables and/or fruits are known to contain abundant amounts of anti-oxidants, and of which two or more vegetables are green vegetables and two or more vegetable are red or orange vegetables. The above assembly of vegetables and fruits can provide a spectrum of highly desirable nutrients, especially anti-oxidants, vitamins, and minerals from vegetables and fruits. Green vegetables include spinach, broccoli, celery hearts, green pepper, asparagus, lemon, mustard green, kale, cabbage, sweet potato leaves, Garland chrysanthemum, lettuce rape, crowndaisy, rape, water spinach, edible amaranth, Notoginseng radix, Chinese cabbage, green bean sprouts, cucumber, zucchini, and winter melon. The juice prepared from those green vegetables appears a range of green color, from light to deep green. Red or orange vegetables include red tomato, carrot, amaranth, red capsicum, beet root, and pumpkin. The juice prepared from those red or orange vegetables appears a range of red or orange color, from light to deep red or orange.

There are at least several tens of vegetables and fruits that are suitable for assembling the set of vegetables and fruits for preparing juice (or combination of juice and pieces) to cook rice. In addition to those vegetables mentioned in the paragraph above, there are also red grapes, blue berries, strawberries, grape fruit, orange, apple, green papaya, green grapes, plum, peach, cantaloupe, coconut, red dates, and other fruits; onion, cauliflower, egg plant, green day-lily, several varieties of mushrooms, fungus, see weed, green algae, garlic, ginger, coriander, parsley, thyme, and other vegetables. Many vegetables and fruits have a variety of species or breeds. In assembling the set of vegetables and fruits for preparing the Juiced-up Rice of the present invention, if more than one species or breed of a vegetable or fruit is chosen, their relative proportions in the entire set of vegetables and fruits are reduced.

In assembling the set of vegetables and fruits for most of the applications in this prevention, taking into consideration that most fruits have relatively high sugar content, vegetables should constitute a major content of the set of vegetables and fruits. And, among the vegetables, certain vegetables with relatively high nutritional contents will have higher weights in the composition. For example, in a combination of ten vegetables and fruits, the four vegetables, spinach, broccoli, tomato, and carrot account for more than 50%, while the other six vegetables and fruits account for less than 50%.

As for the raw rice for cooking with vegetable and fruit juice, it can be of one strain. It may also be a mixture of several strains of desired proportions. The white rice may be mixed with brown rice, black sweet rice, long-grain rice, wild rice, millet, or other kinds of rice. Rice may also be mixed with buckwheat, lotus seeds, oats, or other kinds of grains or seeds. These various combinations may be prepared for enhancing nutritional values and for enhancing flavor.

Raising the Nutritional Content of Vegetable and Fruit Nutrients-Enriched Rice

The process for preparing the nutrients-enriched rice of the present invention embodies a step in which the rice is cooked with juice prepared from vegetables and fruits. In this step, rice grains absorb and adsorb the nutrients contained in juices and minute pieces of vegetables and fruits. In such an approach of providing nutrients-enriched rice, the rice serves not only as a major source of carbohydrate and calorie but also as a vehicle of many nutrients. Additional derivations of the present invention extend the main concept described above and pertain to methods for preparing further nutrients-enriched rice:

(1) The juice prepared from vegetables and fruits is concentrated by removing some water before being used to cook rice. Depending on the assembled composition of vegetables and fruits, 10 to 50% of the water in the juice may be removed.

(2) The Juiced-up Rice may be further enriched with one or more purified nutrients. Such nutrients include Vitamin B12, Vitamin K, selenium, etc. These Juiced-up Rice preparations that are further enriched by one or more purified nutrient may be provided to patients who lack the specified nutrient (e.g. patients with pernicious anemia are provided with Juiced-up Rice that is further enriched with Vitamin B12). Based on this concept, Juiced-up Rice may be further enriched with nutrients, such as Vitamin A and iron, and provided to patients who are in need of those nutrients. While many patients do not comply with the schedule of taking supplements or medicine prescribed for them, they eat their staple food regularly when have their meals. When nutrients are carried in the rice they eat, they will take in those nutrients as they eat rice. For making such Juiced-up Rice that is further enriched with a purified nutrient, the juice used for making Juiced-up Rice is added with the purified nutrient that is to be fortified in the rice.

(3) The Juiced-up Rice may be further enriched with extract from meat, fish, bean, or milk product, such as extract of chicken, soybean, etc. For making such product, the extract is dried, made into powder form, and added into the juice used to prepare the Juiced-up Rice.

(4) The Juiced-up Rice may be further enriched with one or more herbs. Some herbs, such as Ginseng, Ganodorma lucidum, Cordiceps, etc. are used often in cooking. There are two methods to supplement the juice used for preparing Juiced-up Rice with herbs. One is to grind dried herbs into fine powder and then add it into the juice for use to cook rice. The other is to blend fresh herbs into thin paste and then mix it with the juice to cook rice.

The Application of Juiced-Up Rice

The vegetable and fruit nutrients-enriched rice may be applied in several ways:

(1) The freshly prepared Juiced-up Rice may be spiced and used by itself. It may also substitute white rice and be used together with other foods. It may also substitute white rice and be used as an ingredient for preparing other foods, e.g. for use in preparing rice meals with vegetables and meats or fish, etc.

(2) The Juiced-up Rice may be used as an ingredient to prepare rice meals that are stored at cold for use within the next few days. The rice meals may also be sterilized and cooled or frozen, packaged and sealed, and used within extended periods in the future.

(3) The Juiced-up Rice and the rice meals derived from it may be dehydrated, sterilized, and sealed and used in the future. Upon use, the Juiced-up Rice is mixed with 1.2-2.5 times (volume to weight ratio) water, brought to boiling, and simmered for 15 minutes. It is ready to be used as freshly prepared Juiced-up Rice.

### EXAMPLES

In the present invention, several embodiments for preparing vegetable and fruit juice are provided. In the preferred embodiment of this invention, the individual juices are prepared (processed and juiced) separately and the prepared juices are combined altogether or in divisions (sets) according to desired proportions. In another embodiment, the vegetables and fruits are divided into two or more sets and then processed and juiced. In still another embodiment, the vegetables and fruits are combined according to desired proportions and then processed and juiced altogether.

Several embodiments for cooking rice in the prepared juices are provided. In one embodiment, the rice is cooked in the juice from all desired vegetables and fruits. In the other embodiment, rice is cooked in different sets of juices separately, and the cooked rice then combined, either mixed or simply placed side-by-side, according to desired proportions. For example, Rice is cooked separately in juice prepared with a combination of green vegetables and in juice prepared from red or orange vegetables, and the two preparations of rice are combined, either mixed or placed side-by-side. There are several advantages for cooking rice in different sets of juices separately:

(1) The rice cooked separately in different sets of rice has different colors and appearance. This can enhance the delight of using the rice. For example, the rice cooked in the juice prepared from a set of green vegetables appears greenish; the rice cooked in the juice prepared from red or orange vegetables appears reddish or orange. The combined rice preparation, either mixed or placed side-by-side, presents multiple colors.

(2) The separately cooked rice can be combined at desired proportions to attain different sets of nutrition and tastes.

(3) Different regions produce different vegetables and fruits. Different sets of vegetables and fruits may be assembled, processed, and juiced, and used for cooking rice in different regions. The rice prepared in different regions may be transported to a central location for combination.

### Example 1

Preparing Juiced-Up Rice in Juice Prepared from Five Vegetables

Fresh spinach 2 Kg, broccoli 2 Kg, tomato 2 Kg, carrots 2 Kg, and garlic 0.2 Kg were obtained. The first 4 items were cleaned by washing with water and the water was removed by shaking and swinging the vegetables. The leaves and stems of spinach, the flower and stems of broccoli, tomato with skin, and carrots with skin were cut into 1-2 cm long (thick) pieces and chunks, and juiced individually with JuiceMan II (a juicer). The pieces of the flower part of broccoli and skinned garlic were ground into paste with Ladyship Blender. Under a magnifying glass, the particles in the paste were minute. The juice from the stems of broccoli and the paste from the flower of broccoli were mixed. Finally, the juice (or paste) of the above five vegetables were mixed at the amounts of 1 L, 1 L, 1 L, 0.92 L, and 0.08 L (i.e., spinach:broccoli:tomato:carrot:garlic=25:25:25:23:2) and used for cooking rice as below.

1 Kg of Penlai strain rice (round grains) of a recent crop was washed 3 times and drained with a net. The washed rice was immersed in 1.5 L of the mixed juice prepared above (rice to juice ratio is 1 to 1.5). The rice and juice mixture was placed at room temperature for 20 minutes and then cooked in a steamer rice cooker (Tatung brand) for 25 minutes. The rice was kept covered for additional 15 minutes.

### Example 2

Red and Green Dual-Color Juiced-Up Rice Cooked with 12 Vegetables

Six green vegetables, including spinach, broccoli, celery hearts, green pepper (green capsicum), asparagus, and lime, and six red or orange vegetables, including tomato, carrots, red grapes, “red phoenix leaves” (a vegetable with juicy red leaves indigenous in Taiwan), red pepper (red capsicum), and beet root were obtained. Spinach (root removed), broccoli (stems and flower), celery hearts (leaves and roots removed), green pepper (seeds removed), asparagus (with skin), tomato (with skin), carrots (with skin), red phoenix leaves (leaves and stems), red pepper (red capsicum, seeds removed), and beet root were processed and juiced as spinach and carrots were processed and juiced in Example 1. Lime was juiced using a simple manual crusher without grinding the seeds and skin. Next, the juices obtained from spinach, broccoli, celery hearts, green pepper, asparagus, and lime were mixed at ratios of 25:25:20:15:10:5 (in liters), thus yielding the set of green juices; the juices obtained from tomato, carrots, red grapes, red phoenix leaves, red pepper, and beet root were mixed at the ratios of 25:25:5:20:20:5 (in liters), thus yielding the set of red juice.

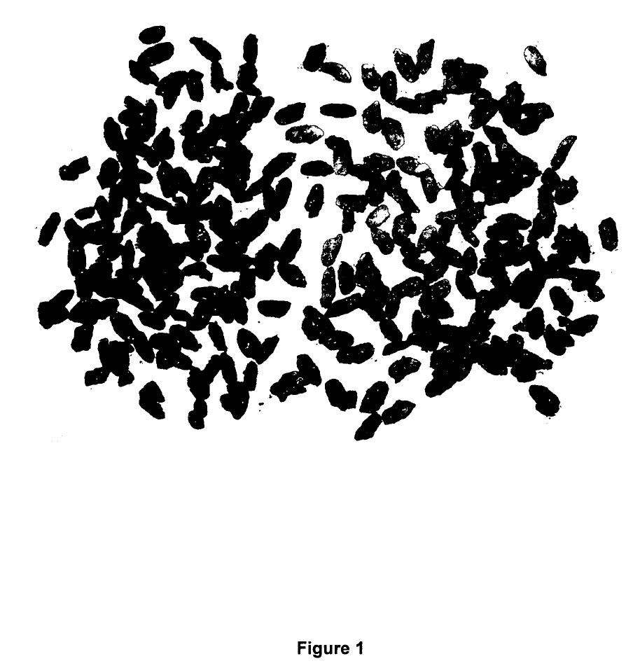

Rice and the green and red juices were mixed at the ratios of 1 and 1.5, kept at room temperature for 20 minutes, and cooked in a steam rice cooker as described in Example 1. The rice thus cooked presented light green and red colors, respectively. The two preparations of rice were combined (not mixed) side-by-side. FIG. 1 shows the grains of freshly cooked rice.

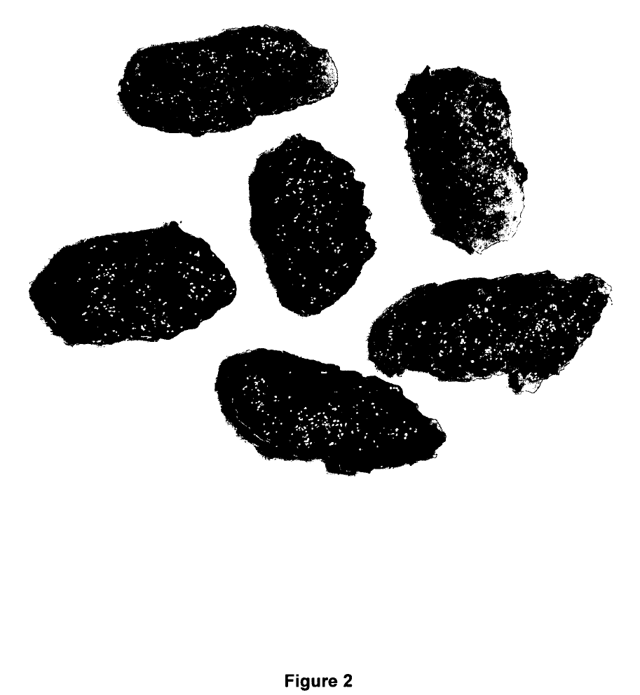

FIG. 2 shows the surface of the rice grains as photographed using a digital camera. Under an enlargement scale, the photograph reveals that the rice grains absorbed not only solution but also adsorb the fine bits of tissues in the juices.

### Example 3

Preparing Fried Rice with Shredded Chicken

A fried rice meal was prepared using Juiced-up Rice as prepared in Example 1, instead of plain rice cooked in water. Using a common recipe, in a preheated, non-sticky frying pan, 20 ml of olive oil was added, and 25 g of minced garlic was poured in the pan and fried for 1 minute. Next, 200 g of shredded chicken and 400 mg of cabbage were poured into the pan and quickly fried for 2 minutes. This cabbage with shredded chicken was mixed with 1000 g of Juiced-up Rice and fried briefly to produce “fried rice with shredded chicken”.

### Example 4

Dehydrated Mixed Red and Green-Colored Juiced-Up Rice

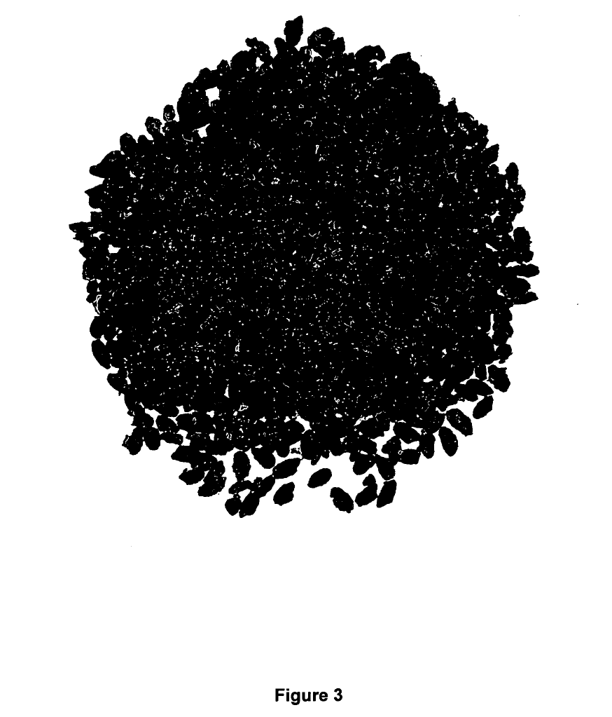

The preparations of red and green Juiced-up Rice, prepared in Example 2, were placed in separate plates and rice grains were loosened and spread apart. The plates were placed in a cold room (4° C.) and blown softly with a fan. After 48 hours, the rice, which was dehydrated, was pooled and collected. The dried red Juiced-up Rice and green Juiced-up Rice were mixed (FIG. 3). The dried rice was placed in plastic bag and stored in a refrigerator.

### REFERENCES

JP56124357, Iwata T and Hayakawa K. Enriched rice (1981).

JP56131349, Moritaka S and Yamamoto H. Vitamin B1-enriched rice and enriched cleaned Barley (1981).

JP58013356, Moritaka S and Yamamoto H. Preparation of enriched polished rice and enriched polished rice (1983).

JP60118153, Misaki M et. al. Production of polished and enriched rice and Barley (1985).

CN1123619, Yuan Z C, Xu X X and Zhu X H. Nutrient enhancing rice (1996).

CN1114539, Wang Y J. Enriched nutritive life rice (1996).

CN1227066, Sun J W et. al. Stable serial rice products rich in folic acid and the producing technology (1999).

CN1404714, Hong C L. Method for cultivation of zinc-rich nutrient rice (2003).

JP2003245049, Matsumoto K et. al. Enrichments for boiled rice (2003).

JP2004275082. Hase E. Nutrient-enriched rice, method and apparatus for processing the same (2004).

Ye X, Al-Babili S, Kloti A, Zhang J, Lucca P, Beyer P, Potrykus I. Engineering the provitamin A (beta-carotene) biosynthetic pathway into (carotenoid-free) rice endosperm. Science 2000; 287(5451):303-5.

Lucca P, Hurrell R, Potrykus I. Fighting iron deficiency anemia with iron-rich rice. J Am Coll Nutr. 2002; 21 (3 Suppl):184S-190S.

1.-22. (canceled)

23. A rice preparation comprising cooked rice grains with adsorbed and absorbed nutrients from juice of vegetables and fruits or from juice of vegetables and fruits plus bits of vegetables and fruits.

24. The rice preparation of claim 23, wherein the vegetables and fruits and/or bits of vegetables and fruits are selected from three or more or five or more vegetables and fruits.

25. The rice preparation of claim 23, wherein the vegetables and fruits comprise spinach, broccoli, tomato, and carrot.

26. The rice preparation of claim 23, wherein the rice is sterilized.

27. The rice preparation of claim 23, wherein the rice is dehydrated.

28. The rice preparation of claim 23, wherein the juice from vegetables and fruits is a concentrated juice with about 10-50% of the water content removed.

29. The rice preparation of claim 23, wherein the juice of vegetables and fruits comprises one or more added purified nutrients.

30. The rice preparation of claim 29, wherein the added purified nutrients comprise vitamin B12, vitamin K, selenium, and vitamin A.

31. The rice preparation of claim 23, wherein the juice of vegetables and fruits comprises one or more extracts from meat, fish, beans, or milk products.

32. The rice preparation of claim 31, wherein the extracts from meat, fish, bean, and milk products comprises nutrients from chicken and soybean.

33. The rice preparation of claim 23, wherein the juice of vegetables and fruits comprises one or more added ingredients of herbs.

34. The rice preparation of claim 33, wherein the herbs comprises ginseng, Cordiceps, and Ganodorma lucidum.

35. A food product comprising the rice preparation of claim 23.

36. The food product of claim 35, wherein the food product is sterilized.

37. The food product of claim 35, wherein the food product is dehydrated.

38. A process for preparing rice containing nutrients from vegetables and fruits comprising:
cooking the rice with juice of vegetables and fruits or juice of vegetables and fruits plus bits of vegetables and fruits, wherein the vegetables and fruits are selected from three or more vegetables and fruits.

39. The process of claim 38, wherein the juice of vegetables and fruits comprises only juice of vegetables and fruits without additional water.

40. The process of claim 38, wherein the process further comprises dehydrating the rice after cooking.

41. The process of claim 38, wherein cooking the rice comprises:
dividing the vegetables and fruits into two or more sets for preparing juices;
cooking the rice in the sets of juices separately; and
combining the separately cooked rice.

42. The process of claim 41, wherein the vegetables and fruits are divided into a set of green vegetables and fruits and a set of red or orange vegetables and fruits.

43. The process of claim 42, wherein the green vegetables and fruits comprises spinach and broccoli and the red or orange vegetables and fruits comprises tomato and carrot.

44. The process of claim 41, further comprising dehydrating the rice after cooking the rice in the sets of juices separately; and mixing the separately cooked rice.
